(19) United States
(12) Patent Application Publication
(10) Pub. No.: US 2009/0059934 A1
(43) Pub. Date: Mar. 5, 2009

(54) METHOD AND DEVICE FOR PROVIDING A BRIDGE IN A NETWORK

(75) Inventors: Pankaj Aggarwal, Lake Mary, FL (US); Hrishikesh Gossain, Lake Mary, FL (US); Shyamal Ramachandran, Lake Mary, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/847,466

(22) Filed: Aug. 30, 2007

(51) Int. Cl. H04L 12/56; H04L 12/28; H04Q 3/38

(52) U.S. Cl. 370/401; 370/338; 370/406

(57) ABSTRACT

A method and device for providing a bridge between a distribution system and a wireless network device as provided increases network availability. According to one aspect, the method includes assigning a first wireless network device to a first wireless distribution system port in response to processing a first identification message received from the first wireless network device. A second wireless network device is then assigned to a second wireless distribution system port in response to processing a second identification message received from the second wireless network device after assigning the first wireless network device to the first wireless distribution system port. The bridge is then provided between the distribution system and the first wireless network device via the first wireless distribution system port.

### FIELD OF THE INVENTION

The present invention relates generally to wireless networking, and in particular to providing a bridge in a wireless mesh network between a distribution system and a wireless network device.

### BACKGROUND

Mesh network technology enables wireless devices to communicate with peers by relaying network data packets through a series of wireless intermediate nodes. The intermediate nodes can be fixed elements of a network infrastructure, or mobile wireless stations that are capable of routing or relaying data packets between neighboring network nodes. A gateway that functions as a bridge between a mesh network and a non-mesh network, such as a wired backhaul network, is called a mesh gateway or an Intelligent Access Point (IAP). A wireless intermediate node, also referred to as a wireless router or a mesh access point, can act as a router, a bridge, or a repeater to relay data packets between neighboring network nodes that are in communication with the wireless intermediate node. Thus, wireless intermediate nodes can extend a communication range of an IAP by relaying data packets between neighboring network nodes.

A mesh network can comprise numerous mesh gateways and mesh access points. The mesh gateways and mesh access points can provide wireless mesh networking to mobile wireless stations by establishing wireless backhaul connections, also referred to as wireless distribution systems (WDSs). This type of mesh networking is referred to as wireless mesh backhaul or infrastructure meshing. Also, a mesh network can comprise mobile wireless stations that act as intermediate nodes by relaying data between nearby mobile stations. This type of mesh networking is referred to as client meshing or ad-hoc networking. A combination of both wireless backhaul meshing and client meshing also can be used.

A large scale wireless mesh network utilizing low-powered, short-range, high-data rate communication devices can thus provide long range wireless networking. Advantages of such wireless mesh networking include low interference and large scale wireless coverage that requires significantly less infrastructure than a cellular network. For example, a wireless mesh network can provide ubiquitous Internet access if a mesh gateway participating in the mesh network is connected to the Internet.

One mode of relaying data through an intermediate node in a mesh network involves providing a bridge between wired or wireless network connections. Intermediate nodes acting as bridges in a network often construct a tree structure of network nodes, where the tree structure is a sub structure of the network. The bridges in the tree structure are designed to prevent loop paths that can potentially disable the network or impair network performance. For example, bridges can automatically detect a loop path using a spanning tree algorithm, which algorithms are well known by those having ordinary skill in the art, and can then disable some of their ports to form a tree structured sub-network of nodes.

If bridging is used in a mesh network, a wireless backhaul connection of an intermediate node also can be disabled if the wireless backhaul connection causes a loop. However, disabling a wireless backhaul connection can limit the effectiveness and efficiency of a bridged mesh network. For example, nodes associated with a disabled wireless backhaul connection may no longer be able to use a bridging service.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic diagram illustrating a mesh network, according to some embodiments of the present invention.

FIG. 2 is a block diagram illustrating a communications architecture of an Intelligent Access Point (IAP), according to some embodiments of the present invention.

FIG. 3 is a sequence diagram illustrating a method for providing a bridge between a backhaul network and an Intelligent Access Point (IAP), according to some embodiments of the present invention.

FIG. 4 is a general flow diagram illustrating a method for providing a bridge between a distribution system and a wireless network device, according to some embodiments of the present invention.

FIG. 5 is an expanded general flow diagram illustrating a method for providing a bridge between a distribution system and a wireless network device, according to some embodiments of the present invention.

FIG. 6 is an alternative expanded general flow diagram illustrating a method for providing a bridge between a distribution system and a wireless network device, according to some embodiments of the present invention.

FIG. 7 is a block diagram illustrating system components of an Intelligent Access Point (IAP), according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to providing a bridge between a distribution system and a wireless network device. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing a bridge between a distribution system and a wireless network device as described herein. The non-processor circuits may include, but are not limited to, a radio receiver, a radio transmitter, signal drivers, clock circuits, power source circuits, and user input devices. As such, these functions may be interpreted as steps of a method for providing a bridge between a distribution system and a wireless network device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustratively provided to enable persons skilled in the art to make or use the invention and not to limit the scope of the invention which is defined by the claims.

According to one aspect, some embodiments of the present invention define a method for providing a bridge between a distribution system and a first wireless network device. The method includes assigning the first wireless network device to a first wireless distribution system (WDS) port in response to processing a first identification message received from the first wireless network device. Next, a second wireless network device is assigned to a second WDS port in response to processing a second identification message received from the second wireless network device. The bridge is then provided between the distribution system and the first wireless network device via the first WDS port.

Some embodiments of the present invention thus enable a mesh gateway to divide a network port of a WDS network interface into multiple WDS ports depending on a number of identification messages received from nearby wireless network devices. That is, a mesh gateway can create and assign WDS ports dynamically to wireless network devices in response to discovering the wireless network devices. Assigning a separate WDS port for each wireless network device can increase the availability and efficiency of a mesh gateway. That is because even if a WDS port assigned to a wireless network device is blocked after a loop path is detected at the WDS port, a mesh gateway can still provide a bridge for other wireless network devices via separate WDS ports assigned to other wireless network devices. Since mesh gateways can be critical bottlenecks of mesh network traffic, increasing the availability and efficiency of mesh gateways can increase the overall availability and efficiency of a mesh network.

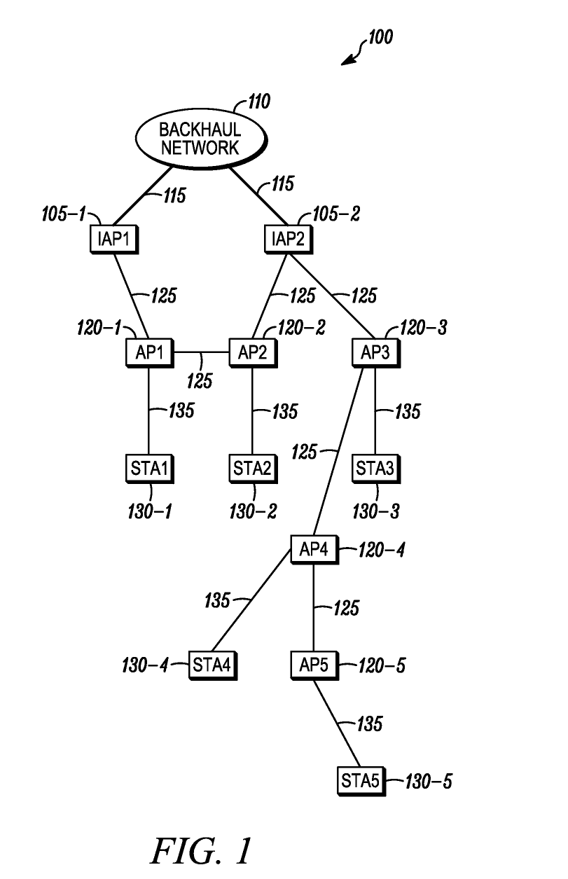

Referring to FIG. 1, a schematic diagram illustrates a mesh network 100, according to some embodiments of the present invention. The mesh network 100 comprises a plurality of Intelligent Access Point (IAP) nodes 105-n (i.e., IAP nodes 105-1 and 105-2) that function as mesh gateways. Each IAP node 105-n is connected to a backhaul network 110 via a corresponding backhaul link 115, and is also connected to one or more mesh access points 120-n (i.e., mesh access points 120-1 to 120-3) via corresponding wireless distribution system (WDS) links 125. Further, the IAP node 105-2 can provide services to mesh access points 120-4 and 120-5 through the mesh access point 120-3. Each mesh access point 120-n functions as an intermediate node for routing mesh network traffic for neighboring nodes, and each mesh access point 120-n typically provides one or more sources of audio, video and/or data information. The mesh access point 120-n may be, for example, a cellular base station or other wireless access point. The backhaul network 110 can be any type of network, such as the Internet or a wired Local Area Network (LAN).

Each mesh access point 120-n is also connected to one or more wireless nodes 130-n (i.e., wireless nodes 130-1 to 130-5, also referred to as wireless stations (STAs) or mesh points), via corresponding wireless links 135. Thus the wireless nodes 130-n can generally be wireless devices capable of receiving packetized audio, video and/or data information. The wireless nodes 130-n can comprise various types of devices such as mobile telephones, handheld radios, notebook computers or in-vehicle radios, and can function as producers or consumers of mesh network traffic. The wireless links 135 can be provided by wireless devices at the mesh access points 120-n, and the WDS links 125 can be provided by separate WDS wireless devices at the mesh access points 120-n. A mesh access point 120-n also can be connected to other mesh access points 120-n via WDS links 125. For example, the mesh access points 120-1 and 120-2 are connected via a WDS link 125, and the mesh access points 120-3 and 120-4 are connected via another WDS link 125.

As known by those having ordinary skill in the art, wireless network devices in a mesh network are generally connected to an IAP via a single WDS port on the IAP. For example, the IAP2 node 105-2 can assign the mesh access points 120-2, 120-3 to a single port of a WDS network interface on the IAP2 node 105-2. That is, the WDS links 125 of the IAP2 node 105-2 can be made through the single port. Thus, if the IAP2 node 105-2 receives a loop detection packet through the single port, a loop path can be detected at the single port and thus the single port can be closed. That means that both of the mesh access points 120-2, 120-3 will no longer be able to access the backhaul network 110 by a bridge service provided by the IAP2 node 105-2.

One way of overcoming the above problem is for the IAP2 node 105-2 to act as a mesh access point to route data packets between the mesh access points 120-2 and 120-3. However, such a solution can be inefficient because data packets from the mesh access point 120-3 need to make five hops in order to pass through the IAP1 node 105-1 and arrive at the backhaul network 110, whereas it would require only two hops to arrive at the backhaul network 110 if the IAP2 node 105-2 could provide a bridge between the mesh access point 120-3 and the IAP2 node 105-2. As described in detail below, some embodiments of the present invention thus enable dividing a network port of a WDS network interface into multiple logical WDS ports.

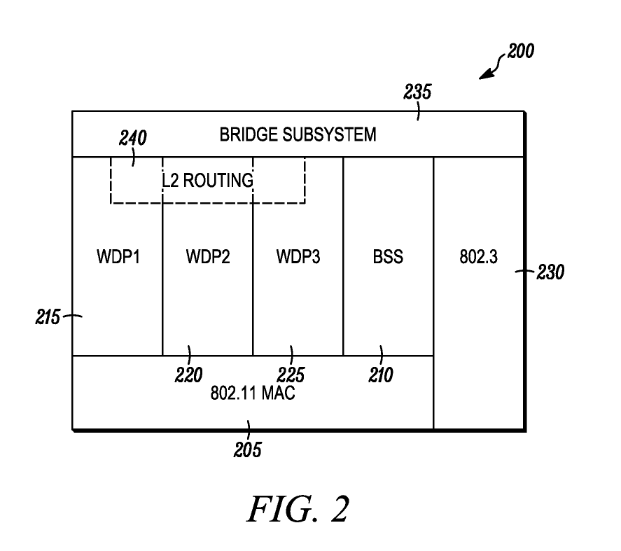

Referring to FIG. 2, a block diagram illustrates a communications architecture 200 of the Intelligent Access Point (IAP) node 105-2, according to some embodiments of the present invention. The communications architecture 200 comprises an Institute of Electrical and Electronics Engineers (IEEE) 802.11 wireless Medium Access Control (MAC) sub-system 205 coupled to two wireless network interfaces: one for providing a base station subsystem (BSS) port 210 and another for providing a wireless distribution system. A network port of the wireless network interface providing the wireless distribution system is divided into three WDS ports: a first WDS port 215, a second WDS port 220, and a third WDS port 225. For example, the WDS ports 215, 220, 225 can be logical WDS ports. The communications architecture 200 also can have a wired distribution system port 230, such as a network port created by an Institute of Electrical and Electronics Engineers (IEEE) 802.3 network sub system. For example, the wired distribution system port 230 can be used to provide the backhaul link 115 of the IAP2 node 105-2. Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

A bridge sub-system 235 and a layer-2 routing sub-system 240 can provide a bridge between the wired distribution system port 230 and the WDS ports 215, 220, 225. For example, a broadcast packet can be received via the wired distribution system port 230 and forwarded to the layer-2 routing sub-system 240, which then can further process the broadcast packet and route it to an appropriate WDS port, such as the WDS port 215.

The WDS ports 215, 220, 225 can be logical WDS ports and can be registered to the bridge sub-system 235 in place of the network port of the WDS network interface. For example, the WDS ports 215, 220, 225 can be backhaul wireless link ports. The WDS network interface can be a backhaul wireless network interface, which is a separate radio operating independently from a normal service radio, such as a wireless network interface for the BSS port 210.

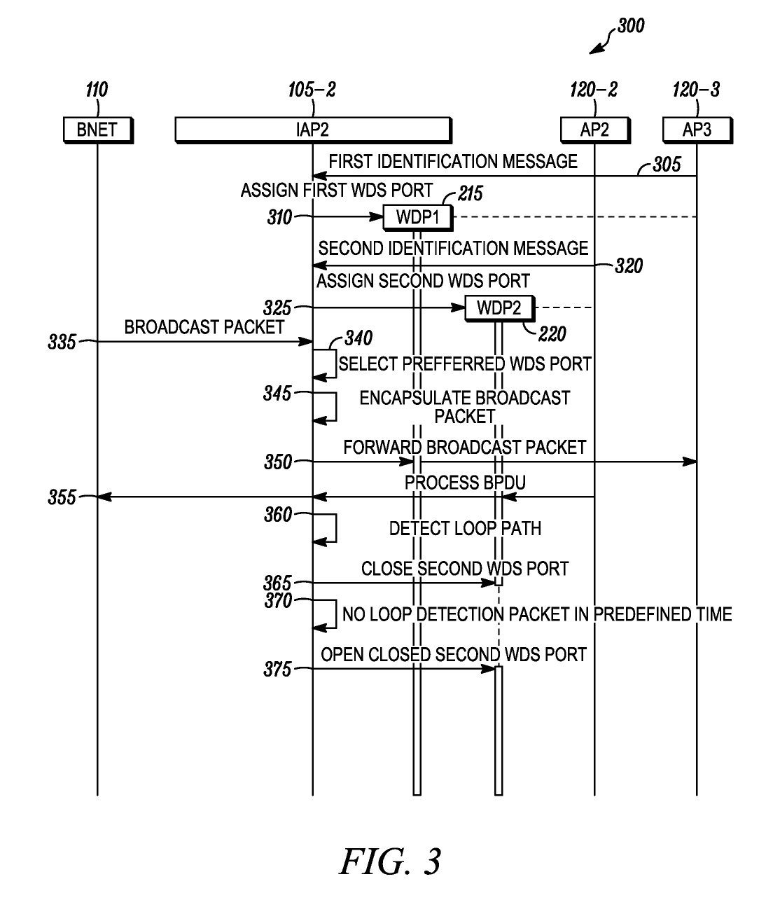

Referring to FIG. 3, a sequence diagram illustrates a method 300 for providing a bridge between the backhaul network 110 and the IAP2 node 105-2 of the mesh network 100, according to some embodiments of the present invention. At step 305, the IAP2 node 105-2 processes a first identification message received from the mesh access point 120-3. For example, the first identification message can be a layer-2 hello message. At step 310, the WDS port 215 is then created and assigned to the mesh access point 120-3. For example, the WDS link 125 between the IAP2 node 105-2 and the mesh access point 120-3 can be established via the WDS port 215.

At step 320, a second identification message is received from the mesh access point 120-2. For example, the second identification message also can be a layer-2 hello message. At step 325, the second WDS port 220 is then created and assigned to the mesh access point 120-2. For example, the WDS link 125 between the IAP2 node 105-2 and the mesh access point 120-2 can be established via the second WDS port 220.

The IAP2 node 105-2 then can provide a bridge between the backhaul link 115 of the IAP2 node 105-2 and the WDS ports 215, 220 that are assigned, respectively, to the mesh access points 120-3, 120-2. For example, the bridge can be provided by an Institute of Electrical and Electronics Engineers (IEEE) 802. Id type bridging system included in the bridge sub-system 235.

As known by those having ordinary skill in the art, the bridge also can be provided by a mesh access point, such as the mesh access point 120-2. For example, the mesh access point 120-2 can be connected to two WDS links 125: one WDS link 125 to the IAP2 node 105-2 and another WDS link 125 to the mesh access point 120-1. Thus a bridge can be provided between the WDS links 125 connected to the mesh access point 120-2.

At step 335, the IAP2 node 105-2 processes a broadcast packet received via the wired distribution system port 230 from the backhaul network 1 10. At step 340, a preferred WDS port is selected from a plurality of open WDS ports, such as the WDS ports 215, 220. For example, the preferred WDS port can be selected based on port status information of the plurality of open WDS ports. If the WDS port 220 has a blocked status, but the WDS port 215 has an open status, the IAP2 node 105-2 can select the WDS port 215 as a preferred WDS port.

At step 345, the broadcast packet is then encapsulated in another packet such as a unicast packet. At step 350, the packet encapsulating the broadcast packet is then forwarded to the mesh access point 120-3 via the WDS port 215. The mesh access point 120-3 then can multicast or broadcast a content of the unicast packet to network devices associated with the mesh access point 120-3, or to network devices listed in a precursor list. A precursor list is maintained by a node and comprises the addresses of all nodes that can reach a particular destination, such as an IAP, through the node that maintains the precursor list. For example, the mesh access point 120-3 can multicast a content of the unicast packet to the wireless node 130-3. Alternatively, the mesh access point 120-3 can select all one hop precursor devices and unicast the encapsulated broadcast packet to all of those devices. Such a unicast process will repeat until there are no remaining one hop devices listed in the precursor list.

At step 355, the IAP2 node 105-2 processes a message such as an IEEE 802.1d Bridge Protocol Data Unit (BPDU) received from the mesh access point 120-2 via the second WDS port 220. Consider, for example, that the BPDU was originally sent from the IAP1 node 105-1. At step 360, a loop path is thus detected in the second WDS port 220. That is because the IAP1 node 105-1 and the IAP2 node 105-2 are connected to the same backhaul network 110, forming a loop. The IAP2 node 105-2 can detect the loop path using, for example, a spanning tree algorithm. At step 365, the second WDS port 220 is therefore closed so as to block the loop path through the second WDS port 220.

According to some embodiments of the present invention, a blocked WDS port can be re-opened after no additional loop detection packets are received during a predefined time period. Thus, at step 370, it can be determined that no additional BPDU packets are received via the second WDS port 220. At step 375, the second WDS port then can be re-opened. For example, the bridge sub-system 235 in the IAP2 node 105-2 can monitor the blocked second WDS port 220 for additional BPDU packets after it is closed. If no additional BPDU packets are received from the mesh access point 120-2 during a predefined time period, the bridge service can re-open the second WDS port 220 and notify the layer-2 routing sub-system 240 of an open status of the second WDS port 220. The layer-2 routing sub-system 240 can use the status information of the WDS ports 215, 220, 225 to make a routing decision, such as selecting a preferred WDS port to forward a unicast packet encapsulating a broadcast packet.

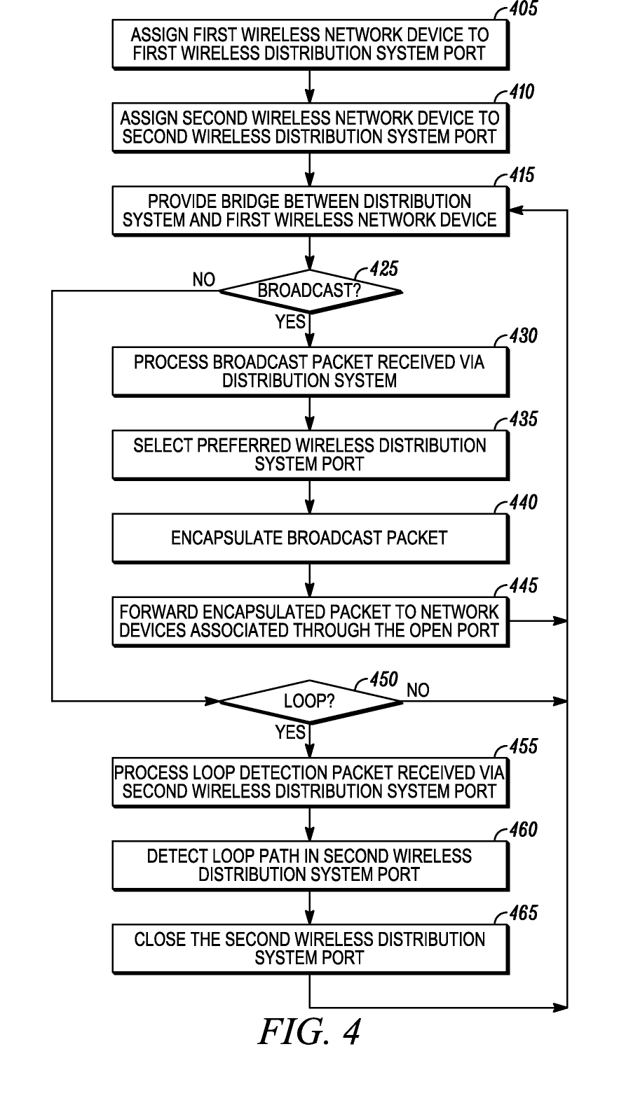

Referring to FIG. 4, a general flow diagram illustrates a method 400 for providing a bridge between a distribution system and a first wireless network device, according to some embodiments of the present invention. At step 405, the first wireless network device is assigned to a first wireless distribution system port in response to processing a first identification message received from the first wireless network device. For example, the IAP2 node 105-2 can assign the mesh access point 120-3 to the WDS port 215 in response to receiving a layer-2 hello message from the mesh access point 120-3.

At step 410, a second wireless network device is assigned to a second wireless distribution system port in response to processing a second identification message received from the second wireless network device, after assigning the first wireless network device to the first wireless distribution system port. For example, the IAP2 node 105-2 can assign the mesh access point 120-2 to the WDS port 220 in response to receiving a layer-2 hello message from the mesh access point 120-2.

At step 415, the bridge is provided between the distribution system and the first wireless network device via the first wireless distribution system port. For example, the IAP2 node 105-2 can provide a bridge between the wired distribution system port 230 and the mesh access point 120-3 via the WDS port 215.

At step 425, it is determined whether a broadcast packet has been received at the first wireless network device. At step 430, if a broadcast packet was received via the distribution system after assigning the second wireless network device to the second wireless distribution system port, the broadcast packet is processed. For example, the IAP2 node 105-2 can process a broadcast packet received via the wired distribution system port 230 after assigning the first and second WDS ports 215, 220 to the mesh access points 120-3 and 120-2, respectively.

At step 435, a preferred wireless distribution system port is selected from a plurality of open wireless distribution system ports where the plurality of open wireless distribution system ports comprises the first and second wireless distribution system ports. For example, the layer-2 routing sub-system 240 can select, from the WDS ports 215, 220, 225, the WDS port 215 as a preferred WDS port based on status information of the WDS ports 215, 220, 225 provided by the bridge sub-system 235. At step 440, the broadcast packet is encapsulated in another packet such as a unicast packet. For example, the layer-2 routing sub-system 240 can encapsulate a broadcast packet received via the wired distribution system port 230.

At step 445, the unicast packet is forwarded to the wireless distribution system port, where the broadcast packet then can be broadcast to network devices associated with the open wireless distribution system ports. For example, the IAP2 node 105-2 can forward a unicast packet encapsulating a broadcast packet to the WDS port 215, which is assigned to the mesh access point 120-3. The mesh access point 120-3 then can multicast a content of the unicast packet to nodes associated with the mesh access point 120-3, such as the wireless node 130-3. Alternatively, the mesh access point 120-3 can forward the packet to a one hop precursor such as the mesh access points 120-4, and the mesh access point 120-4 can then forward the packet to its own one hop precursor that is the mesh access point 120-5.

At step 450, it is determined whether a loop detection packet has been received at the first wireless networking device. At step 455, if a loop detection packet is received via the second WDS port after assigning the second wireless network device to the second wireless distribution system port, the loop detection packet is processed. For example, the IAP2 node 105-2 can process a BPDU received via the WDS port 220. At step 460, a loop path is then detected in the second WDS port in response to processing the loop detection packet. For example, a loop path can be detected in the second WDS port 220 if a BPDU was sent from the IAP1 node 105-1. At step 465, the second WDS port is then closed in response to detecting the loop path in the second wireless distribution system port. For example, the WDS port 220 can be closed after detecting a loop path in the WDS port 220.

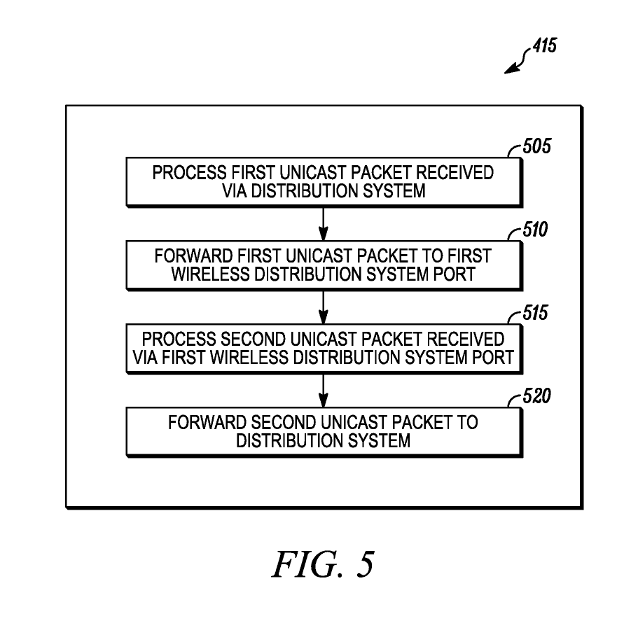

Referring to FIG. 5, an expanded general flow diagram further illustrates step 415 of the method 400 for providing a bridge between a distribution system and a first wireless network device, according to some embodiments of the present invention. At step 505, a first unicast packet received via the distribution system is processed after assigning the second wireless network device to the second wireless distribution system port. For example, the IAP2 node 105-2 can process a unicast packet received via the wired distribution system port 230 after assigning the mesh access point 120-2 to the WDS port 220. At step 510, the first unicast packet is then forwarded to the first wireless distribution system port. For example, the IAP2 node 105-2 can forward a unicast packet to the WDS port 215, which is assigned to the mesh access point 120-3.

At step 515, a second unicast packet received via the first wireless distribution system port is processed after assigning the second wireless network device to the second wireless distribution system port. For example, the IAP2 node 105-2 can process a unicast packet received via the first WDS port 215 after assigning the mesh access point 120-2 to the WDS port 220. At step 520, the second unicast packet is forwarded to the distribution system. For example, the IAP2 node 105-2 can forward a unicast packet received via the WDS port 215 to the wired distribution system port 230.

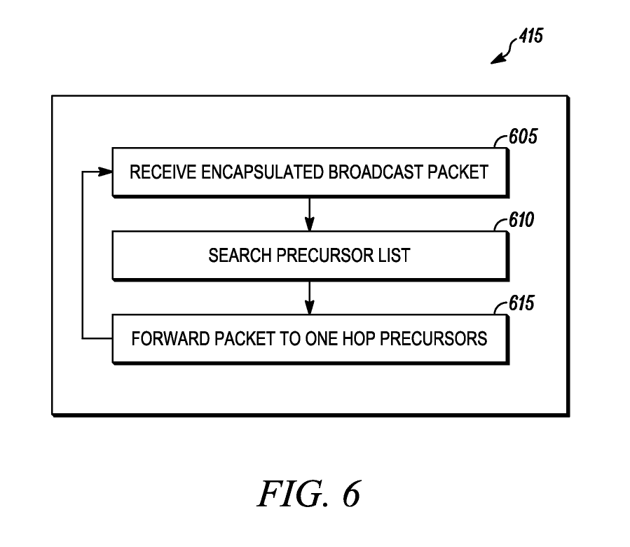

Referring to FIG. 6, an expanded general flow diagram further illustrates step 415 of the method 400 for providing a bridge between a distribution system and a first wireless network device, according to some alternative embodiments of the present invention. At step 605, an encapsulated broadcast packet is received. At step 610, a precursor list is searched for a device that is one hop away. At step 615, the encapsulated broadcast packet is forwarded to a device that is included in the precursor list and is one hop away. The steps 605, 610, 615 are then repeated until the packet has been forwarded to all devices that are included in the precursor list and are one hop away.

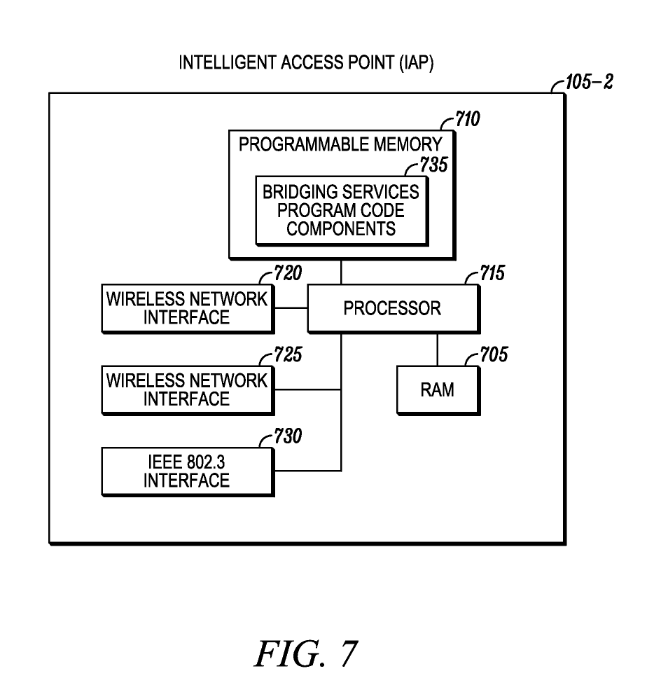

Referring to FIG. 7, a block diagram illustrates system components of the Intelligent Access Point (IAP) node 105-2, according to some embodiments of the present invention. The IAP2 node 105-2 comprises a random access memory (RAM) 705 and a programmable memory 710 that are coupled to a processor 715. The processor 715 also has ports for coupling to wireless network interfaces 720, 725 and a Local Area Network (LAN) interface 730, such as an IEEE 802.3 interface.

The wireless network interfaces 720, 725 can be used to enable the IAP2 node 105-2 to communicate with neighboring network nodes in the mesh network 100. For example, the wireless network interface 720 can provide a network port of a wireless distribution system (WDS) network interface, which network port is divided into the WDS ports 215, 220, 225. Thus, the IAP2 node 105-2 can use the wireless network interface 720 to communicate with the mesh access points 120-2, 120-3, to receive and send data packets. The wireless network interface 725 can provide the base station subsystem (BSS) port 210, and the LAN interface 730 can provide the wired distribution system port 230.

The programmable memory 710 can store operating code (OC) for the processor 715 and code for performing functions associated with a mesh gateway. For example, the programmable memory 710 can comprise bridging services computer readable program code components 735 configured to cause execution of a method for providing a bridge between a distribution system and a first wireless network device as described herein.

Advantages of the present invention thus include increasing network availability and efficiency by dynamically assigning logical wireless distribution system (WDS) ports in response to discovering wireless network devices. By enabling a mesh node, such as a mesh gateway or a mesh access point, to divide an existing WDS port of a wireless network interface into multiple logical WDS ports, the mesh node can assign a separate WDS port to each discovered wireless network device, such as discovered mesh access points. That means that even if some WDS ports are closed because a loop path is detected at the WDS ports, remaining open WDS ports still can be used to provide a bridge between, for example, a backhaul network and wireless network devices connected via the open WDS ports. Thus, unnecessary multi-hop routing of data packets can be reduced. Further, port status information of assigned WDS ports can be used to make appropriate routing decisions, such as selecting a preferred WDS port to forward a broadcast packet to nodes in a mesh network.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for providing a bridge between a distribution system and a first wireless network device, the method comprising:
assigning the first wireless network device to a first wireless distribution system port in response to processing a first identification message received from the first wireless network device;
assigning a second wireless network device to a second wireless distribution system port in response to processing a second identification message received from the second wireless network device after assigning the first wireless network device to the first wireless distribution system port; and
providing the bridge between the distribution system and the first wireless network device via the first wireless distribution system port.

2. The method of claim 1, wherein providing the bridge between the distribution system and the first wireless network device via the first wireless distribution system port comprises:
processing a first unicast packet received via the distribution system after assigning the second wireless network device to the second wireless distribution system port; and
forwarding the first unicast packet to the first wireless distribution system port.

3. The method of claim 2, further comprising:
processing a second unicast packet received via the first wireless distribution system port after assigning the second wireless network device to the second wireless distribution system port; and
forwarding the second unicast packet to the distribution system.

4. The method of claim 1, further comprising:
processing a loop detection packet received via the second wireless distribution system port from the second wireless network device;
detecting a loop path in the second wireless distribution system port in response to processing the loop detection packet; and
closing the second wireless distribution system port in response to detecting the loop path in the second wireless distribution system port.

5. The method of claim 1, further comprising:
processing a broadcast packet received via the distribution system after assigning the second wireless network device to the second wireless distribution system port;
selecting a preferred wireless distribution system port from a plurality of open wireless distribution system ports to forward the broadcast packet, wherein the plurality of open wireless distribution system ports comprises the first and second wireless distribution system ports; and
encapsulating the broadcast packet in a unicast packet.

6. The method of claim 5, wherein each encapsulated broadcast packet is multicast to network devices corresponding to open WDS ports.

7. The method of claim 5, wherein each encapsulated broadcast packet is unicast to network devices corresponding to open WDS ports.

8. The method of claim 5, wherein the preferred wireless distribution system port is selected from the plurality of open wireless distribution system ports.

9. The method of claim 1, wherein the bridge is provided by an Institute of Electrical and Electronics Engineers (IEEE) 802.1d type bridging system.

10. The method of claim 2, wherein the loop detection packet is an Institute of Electrical and Electronics Engineers (IEEE) 802.1d Bridge Protocol Data Unit (BPDU).

11. The method of claim 1, wherein the first wireless distribution system port and the second wireless distribution system port are logical wireless distribution system ports.

12. The method of claim 1, wherein the first wireless distribution system port and the second wireless distribution system port are backhaul wireless link ports.

13. The method of claim 1, wherein the first wireless network device and the second wireless network device are mesh access points.

14. The method of claim 4, wherein the loop path in the second wireless distribution system port is detected using a spanning tree algorithm.

15. The method of claim 1, wherein the bridge is provided by a mesh access point.

16. The method of claim 1, wherein the bridge is provided by an intelligent access point (IAP).

17. The method of claim 1, wherein the first identification message and the second identification message are layer-2 routing hello messages from a wireless mesh network device.

18. The method of claim 1, wherein the first identification message and the second identification message are neighbor discovery packet or beacons

19. The method of claim 4, wherein the second wireless distribution system port is re-opened after no additional loop detection packets are received during a predefined time period.

20. A device for providing a bridge between a distribution system and a first wireless network device, comprising:
means for assigning the first wireless network device to a first wireless distribution system port in response to processing a first identification message received from the first wireless network device;
means for assigning a second wireless network device to a second wireless distribution system port in response to processing a second identification message received from the second wireless network device after assigning the first wireless network device to the first wireless distribution system port; and
means for providing the bridge between the distribution system and the first wireless network device via the first wireless distribution system port.
